(19) United States
(12) Patent Application Publication
(10) Pub. No.: US 2008/0270211 A1
(43) Pub. Date: Oct. 30, 2008

(54) METHOD AND SYSTEM FOR MODIFYING A MEETING ATTENDEE LIST OF AN EMAIL CALENDAR APPLICATION

(76) Inventors: RAYMOND VANDER VEEN, Waterloo (CA); Neil Adams, Waterloo (CA); Mark Michael, Kitchener (CA)

Correspondence Address: McCarthy Tetrault LLP, Box 48, Suite #4700 Toronto Dominion Bank Tower, TORONTO, ON, M5K 1E6, CA

(21) Appl. No.: 11/739,704

(22) Filed: Apr. 25, 2007

(51) Int. Cl. G06Q 10/00

(52) U.S. Cl. 705/8

(57) ABSTRACT

A method for updating a list of attendees for a meeting scheduled by a meeting organizer through a user interface of an electronic calendar presented on a display of a system, the system being coupled to respective attendee systems of attendees of the meeting over a network, the method comprising: distributing the list of attendees to the attendee systems; receiving a signal indicating whether a request message from an attendee system is required to request permission for the attendee system to at least one of add and remove one or more selected attendees from the list of attendees; if the request message is required: receiving the request message from the attendee system; presenting the request message to the meeting organizer on the display with a choice of responses for responding to the request message; and, receiving a signal selecting a response from the choice of responses; wherein the choice of responses has an accept response which, when selected, causes the list of attendees to be updated in accordance with the request message to produce an updated list of attendees.

### FIELD OF THE APPLICATION

This application relates to the field of electronic calendars and meeting scheduling, and more specifically, to a method and system for modifying a meeting attendee list for an electronic calendar of an electronic mail application.

### BACKGROUND

Current wireless mobile communication devices include microprocessors, memory, soundcards, and run one or more software applications. Examples of software applications used in these wireless devices include micro-browsers, address books, electronic mail (“email”) clients, instant messaging (“IM”) clients, and wavetable instruments. Additionally, wireless devices have access to a plurality of services via the Internet. A wireless device may, for example, be used to browse Web sites on the Internet, to transmit and receive graphics, and to execute streaming audio and/or video applications. The transfer of Internet content to and from wireless device is typically facilitated by the Wireless Application Protocol (“WAP”), which integrates the Internet and other networks with wireless network platforms.

Email applications typically include a calendar function which allows a user to schedule meetings, appointments, and other tasks. For example, Outlook™ from Microsoft Corp. includes a calendar function that allows a user to organize meetings using email. Meetings are organized in Outlook™ based on a model that has three basic components: an organizer, participants, and a location. In addition, in an Outlook™ meeting there are distinct roles that dictate what a person does and the amount of control he or she has. In Outlook™, a meeting is an activity that the user schedules in his or her calendar that involves inviting other people or reserving resources. The people involved have the following distinct titles and roles: meeting organizer and attendee. The meeting organizer is the user who sets up a meeting. The organizer is the only person who can change the meeting details once it has been set up. Also, in Outlook™, a new organizer cannot be assigned to an existing meeting. Once a user is the organizer, that user is always the organizer. Any user who is invited to the meeting is considered an attendee. There are two categories of attendee: required and optional. Once an attendee is added to the attendee list, that person will always be considered an attendee for the meeting. Even if an attendee declines a meeting, he or she is still considered an attendee. In Outlook™, the location/resource is the place where the meeting will occur. It is sometimes referred to as the resource.

When meetings are scheduled and maintained in Outlook™, a user can improve the efficiency of the process because Outlook™ keeps track of the details using its email inbox and calendar functions. When these details change, they can be updated for everyone, all at once, with the click of a button. The process of setting up a meeting in Outlook™ is as follows. First, the meeting organizer schedules the meeting and sends all of the participants a special type of message called a “meeting request”. The details of the meeting request may be viewed via the “appointment” tab or window of the meeting request. This request is delivered to the email inboxes of all of the meeting participants. Once the request is in the attendee's inbox, Outlook™ recognizes it as something that belongs in the calendar and puts it there as a “tentative” entry until the attendee has a chance to respond. Attendees read the request and respond. A “meeting response”, which is similar to a meeting request, is sent back to the inbox of the meeting organizer—and just as it did with the requests, Outlook™ recognizes each response as something special. The meeting entry is updated in the organizer's calendar with information about who is coming.

The comings and goings of meeting requests and their related calendar entries are tracked in Outlook™ by an application nick-named the “sniffer.” The meeting requests that a meeting organizer sends to attendees, as well as their responses, are detected by the sniffer as they sit in the organizer's inbox. The sniffer then updates the calendar and the requests themselves with the relevant information. When an attendee receives a meeting request, the sniffer automatically enters that request as a tentative item in the attendee's calendar to help reduce their chances of getting double-booked.

In Outlook™, the meeting organizer can change any aspect of the meeting, at any time, after the meeting request has been sent. To do this, first the meeting organizer would make his or her changes in the meeting request in his or her calendar, and then the meeting organizer would send an update to the people who need to know about the change by clicking on a “send update” button.

In Outlook™, when a meeting request lands in an attendee's inbox, it is automatically added to the attendee's calendar. This reduces the potential for double-bookings and helps the attendee to avoid missing meetings. The attendee still needs to reply to the meeting organizer, confirming his or her attendance. To respond to a meeting request, the attendee has to click one of the buttons in the request. When this is done, a meeting response is created and sent to the meeting organizer. In general, once an attendee responds, the request is removed from his or her inbox. The response buttons in the request are as follows. The “Accept” button is selected when the attendee knows that he or she will be able to attend the meeting. When the attendee accepts a meeting, the meeting is scheduled in his or her calendar and he or she receives updates if the meeting organizer changes the details of the meeting. The “Decline” button is selected when the attendee knows that he or she will not be able to attend the meeting. Declining a meeting deletes the item from the attendee's calendar (freeing that block of time), but it does not sever the attendees ties with the meeting: The attendee will still get updates if the meeting organizer makes them and the attendee will have the opportunity to respond to the update. If the attendee truly wants to opt out of a meeting, the attendee will have to ask the organizer to remove his or her name from the attendee list. The “Tentative” button is selected when the attendee is interested in the meeting, but is not sure whether he or she will be able to attend.

The “Scheduling” tab or window in the meeting request allows an attendee or organizer to view a list of all the people who were invited to the meeting. Note, however, that only the meeting organizer knows who is coming for sure because only the meeting organizer receives the responses to the meeting request, and it's the responses that report back to the meeting organizer about who is coming.

In Outlook™, it is possible for an attendee to forward a meeting request to someone else. When an attendee forwards a meeting request, the person that it is forwarded to will respond directly to the meeting organizer. That is, when that attendee responds to the meeting request, the meeting organizer will receive a message directly from that person—the attendee originally forwarding the meeting request will be out of the loop. However, such a forwarded request may be an unpleasant surprise to the organizer as there may be space limitations for the meeting location, there may be costs associated with the meeting (e.g., lunch, etc.), or the subject matter of the meeting may be controversial or confidential. In these situations, it is often best for the attendee to ask the meeting organizer to add a new attendee rather than taking matters into his or her own hands.

Now, users of wireless and other devices may typically use a calendar application on their devices, and the calendar may be linked wirelessly with a desktop version of the calendar (e.g., outlooks). When a wireless device user organizes a meeting for one or more other users of the same calendar application, a list of attendees is created through the device's calendar application user interface (“UI”) or graphical user interface (“GUI”).

Consider the following scenario. User “A” creates a meeting request through the appointment tab of an application such as Outlook™ and invites users “B”, “C”, and “D”. Thus, user A is the meeting organizer and users B, C, and D are the attendees. One problem faced by users of such a calendar application is that, as the meeting organizer, only user A can change the list of attendees (or invitees). For example, user B may want to add a user E to the list of attendees. However, the only way to accomplish this effectively is for user B to ask user A to add user E to the attendee list. This causes extra email and/or telephone use, and generally a waste of resources.

A need therefore exists for an improved method and system for allowing attendees of a meeting scheduled through an electronic calendar application to modify a list of attendees for the meeting. Accordingly, a solution that addresses, at least in part, the above and other shortcomings is desired.

### BRIEF DESCRIPTION OF THE DRAWINGS

Further features and advantages of the embodiments of the present application will become apparent from the following detailed description, taken in combination with the appended drawings, in which:

FIG. 1 is a block diagram illustrating a data processing system adapted for implementing an embodiment of the application;

FIG. 2 is a block diagram illustrating a wireless device and a wireless communications system adapted for implementing an embodiment of the application;

FIG. 3 is a block diagram illustrating a memory of the wireless device of FIG. 2;

FIG. 4 is a screen capture illustrating an appointment window of an exemplary graphical user interface (“GUI”) for composing a meeting request;

FIG. 5 is a screen capture illustrating a scheduling window of the exemplary graphical user interface (“GUI”) of FIG. 4;

FIG. 6 is a screen capture illustrating an address book pop-up window for selecting attendees for the meeting request of FIGS. 4 and 5;

FIG. 7 is a screen capture illustrating a response window for composing a meeting response to the meeting request of FIGS. 4 and 5;

FIG. 8 is a screen capture illustrating an appointment window of a graphical user interface (“GUI”) for composing a meeting request in accordance with an embodiment of the application;

FIG. 9 is a screen capture illustrating a response window for composing a meeting response to the meeting request of FIG. 8 in accordance with an embodiment of the application;

FIG. 10 is a screen capture illustrating an add attendee prompt dialog box in accordance with an embodiment of the application; and,

FIG. 11 is a flowchart illustrating operations of modules within the memory of a data processing system for updating a list of attendees for a meeting scheduled by a meeting organizer through a user interface of an electronic calendar presented on a display of the system, the system being coupled to respective attendee systems of attendees of the meeting over a network, in accordance with an embodiment of the application.

It will be noted that throughout the appended drawings, like features are identified by like reference numerals.

### DETAILED DESCRIPTION OF THE PREFERRED EMBODIMENTS

In the following description, details are set forth to provide an understanding of the application. In some instances, certain software, circuits, structures and techniques have not been described or shown in detail in order not to obscure the application. Embodiments of the present application may be implemented in any computer programming language provided that the operating system of the data processing system provides the facilities that may support the requirements of the application. Any limitations presented would be a result of a particular type of operating system or computer programming language and would not be a limitation of the present application.

According to one aspect of the application, there is provided a method for updating a list of attendees for a meeting scheduled by a meeting organizer through a user interface of an electronic calendar presented on a display of a system, the system being coupled to respective attendee systems of attendees of the meeting over a network, the method comprising: distributing the list of attendees to the attendee systems; receiving a signal indicating whether a request message from an attendee system is required to request permission for the attendee system to at least one of add and remove one or more selected attendees from the list of attendees; if the request message is required: receiving the request message from the attendee system; presenting the request message to the meeting organizer on the display with a choice of responses for responding to the request message; and, receiving a signal selecting a response from the choice of responses; wherein the choice of responses has an accept response which, when selected, causes the list of attendees to be updated in accordance with the request message to produce an updated list of attendees.

In accordance with further aspects of the present application there are provided apparatus such as a data processing system and a wireless device, methods for adapting these, as well as articles of manufacture such as a computer readable medium having program instructions recorded therein for practising the method of the application.

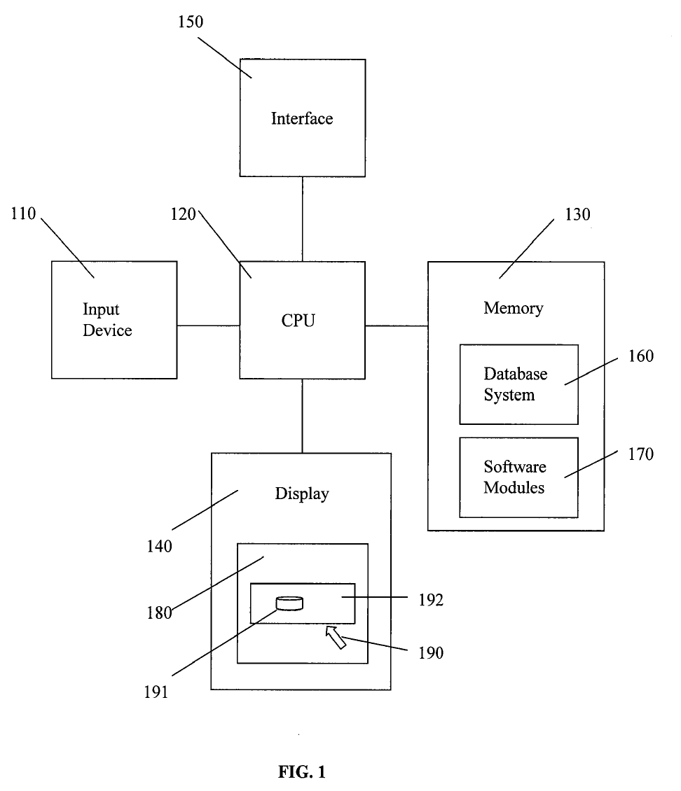

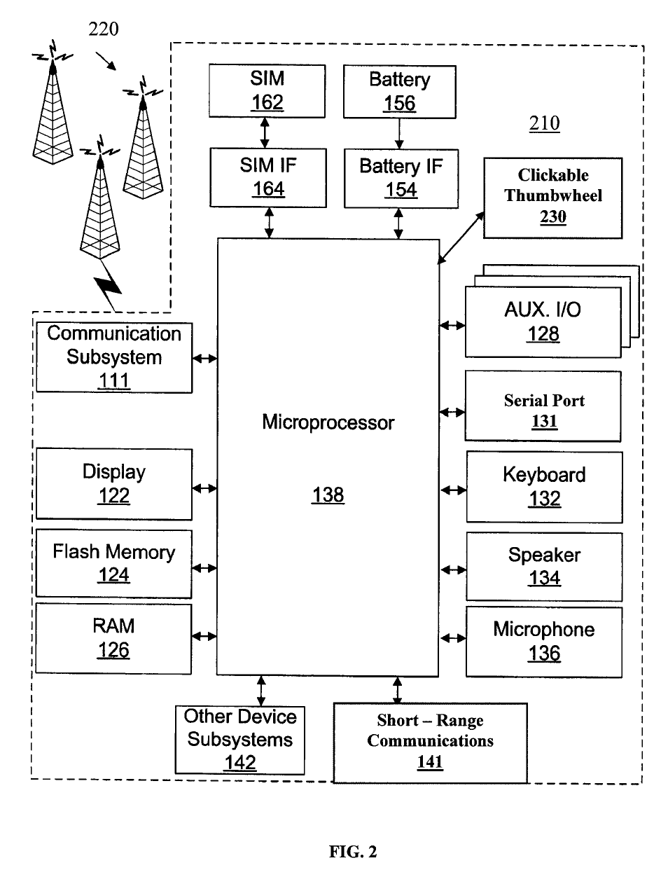

FIG. 1 is a block diagram illustrating a data processing system 100 adapted for implementing an embodiment of the application. The data processing system 100 includes an input device 110, a central processing unit or CPU 120, memory 130, a display 140, and an interface 150. The input device 110 may include a keyboard, mouse, trackball, remote control, or similar device. The CPU 120 may include dedicated coprocessors and memory devices. The memory 130 may include RAM, ROM, or disk devices. The display 140 may include a computer screen, terminal device, or a hardcopy producing output device such as a printer or plotter. And, the interface 150 may include a network connection including an Internet connection and a wireless network 220 connection (see FIG. 2). The data processing system 100 is adapted for communicating with wireless devices 210 over a wireless network 220.

The data processing system 100 may be a server system or a personal computer (“PC”) system. The CPU 120 of the system 100 is operatively coupled to memory 130 which stores an operating system (not shown) for general management of the system 100. The interface 150 may be used for communicating to external data processing systems (e.g., 210 in FIG. 2) through a network (such as the Internet) or wireless network 220 (see FIG. 2).

The data processing system 100 may include a database system 160 for storing and accessing programming information. The database system 160 may include a database management system (“DBMS”) and a database and is stored in the memory 130 of the data processing system 100.

The CPU 120 of the system 100 is typically coupled to one or more devices 110 for receiving user commands or queries and for displaying the results of these commands or queries to the user on a display 140. As mentioned, the memory 130 may include a variety of storage devices including internal memory and external mass storage typically arranged in a hierarchy of storage as understood to those skilled in the art.

A user may interact with the data processing system 100 and its software modules 170 using a graphical user interface (“GUI”) 180. The GUI 180 may be Web-based and may be used for monitoring, managing, and accessing the data processing system 100. GUIs are supported by common operating systems and provide a display format which enables a user to choose commands, execute application programs, manage computer files, and perform other functions by selecting pictorial representations known as icons, or items from a menu through use of an input or pointing device such as a mouse 110. In general, a GUI is used to convey information to and receive commands from users and generally includes a variety of GUI objects or controls, including icons, toolbars, drop-down menus, text, dialog boxes, buttons, and the like. A user typically interacts with a GUI 180 presented on a display 140 by using an input or pointing device (e.g., a mouse) 110 to position a pointer or cursor 190 over an object 191 and by “clicking” on the object 191.

Typically, a GUI based system presents application, system status, and other information to the user in “windows” appearing on the display 140. A window 192 is a more or less rectangular area within the display 140 in which a user may view an application or a document. Such a window 192 may be open, closed, displayed full screen, reduced to an icon, increased or reduced in size, or moved to different areas of the display 140. Multiple windows may be displayed simultaneously, such as: windows included within other windows, windows overlapping other windows, or windows tiled within the display area.

Thus, the data processing system 100 includes computer executable programmed instructions for directing the system 100 to implement the embodiments of the present application. The programmed instructions may be embodied in one or more hardware or software modules 170 resident in the memory 130 of the data processing system 100. Alternatively, the programmed instructions may be embodied on a computer readable medium (such as a CD disk or floppy disk) which may be used for transporting the programmed instructions to the memory 130 of the data processing system 100. Alternatively, the programmed instructions may be embedded in a computer-readable signal or signal-bearing medium that is uploaded to a network by a vendor or supplier of the programmed instructions, and this signal or signal-bearing medium may be downloaded through the interface 150 to the data processing system 100 from the network by end users or potential buyers.

FIG. 2 is a block diagram illustrating a wireless device 210 and a wireless network 220 adapted for implementing an embodiment of the invention. Typically, the wireless device 210 is a handheld device 210. The wireless network 220 includes antenna, base stations, and supporting radio equipment, known to those of ordinary skill in the art, for supporting wireless communications between the wireless device 210, other wireless devices (not shown), and other systems such as the data processing system 100. The wireless network 220 may be coupled to a wireless network gateway (not shown) and to a wide area network (not shown) to which the data processing system 100 may be coupled through its interface 150.

The wireless device 210 is a two-way communication device having at least voice and advanced data communication capabilities, including the capability to communicate with other computer systems 100. Depending on the functionality provided by the device 210, it may be referred to as a data messaging device, a two-way pager, a cellular telephone with data messaging capabilities, a wireless Internet appliance, a data communication device (with or without telephony capabilities), a Wi-Fi device, a WLAN device, or a dual-mode (i.e., Wi-Fi and cellular) device. The device 210 may communicate with any one of a plurality of fixed transceiver stations within its geographic coverage area.

The wireless device 210 will normally incorporate a communication subsystem 111, which includes a RF receiver, a RF transmitter, and associated components, such as one or more (preferably embedded or internal) antenna elements, local oscillators (“LOs”), and a processing module such as a digital signal processor (“DSP”) (all not shown). As will be apparent to those skilled in the field of communications, the particular design of the communication subsystem 111 depends on the communication network 220 in which the device 210 is intended to operate.

Cellular network access is associated with a subscriber or user of the device 210 and therefore the device 210 may require a Subscriber Identity Module (or “SIM” card) 162 to be inserted in a SIM interface (“IF”) 164 in order to operate in the network (e.g., a GSM network).

The device 210 is a battery-powered device so it also includes a battery IF 154 for receiving one or more rechargeable batteries 156. Such a battery 156 provides electrical power to most if not all electrical circuitry in the device 210, and the battery IF 154 provides for a mechanical and electrical connection for it. The battery IF 154 is coupled to a regulator (not shown) which provides power to the circuitry of the device 210.

The wireless device 210 includes a microprocessor 138 which controls overall operation of the device 210. Communication functions, including at least data and voice communications, are performed through the communication subsystem 111. The microprocessor 138 also interacts with additional device subsystems such as a display 122, a flash memory 124 or other persistent store, a random access memory (“RAM”) 126, auxiliary input/output (“I/O”) subsystems 128, a serial port (e.g., a universal serial bus (“USB”) port) 131, a keyboard 132, a clickable thumbwheel 230, a speaker 134, a microphone 136, a short-range communications subsystem 141, and any other device subsystems generally designated at 142. Some of the subsystems shown in FIG. 2 perform communication-related functions, whereas other subsystems may provide “resident” or on-device functions. Notably, some subsystems, such as the keyboard 132 and display 122, and clickable thumbwheel 230, for example, may be used for both communication-related functions, such as entering a text message for transmission over a communication network 220, and device-resident functions such as a calculator or task list. Operating system software used by the microprocessor 138 is preferably stored in a persistent store such as the flash memory 124, which may alternatively be a read-only memory (“ROM”) or similar storage element (not shown). Those skilled in the art will appreciate that the operating system, specific device applications, or parts thereof, may be temporarily loaded into a volatile store such as RAM 126.

The microprocessor 138, in addition to its operating system functions, preferably enables execution of software applications on the device 210. A predetermined set of applications which control basic device operations, including at least data and voice communication applications, will normally be installed on the device 210 during its manufacture. A preferred application that may be loaded onto the device 210 may be a personal information manager (“PIM”) application having the ability to organize and manage data items relating to the user such as, but not limited to, instant messaging (“IM”), email, calendar events, voice mails, appointments, and task items. Naturally, one or more memory stores are available on the device 210 and SIM 162 to facilitate storage of PIM data items and other information.

The PIM application preferably has the ability to send and receive data items via the wireless network 220. In a preferred embodiment, PIM data items are seamlessly integrated, synchronized, and updated via the wireless network 220, with the wireless device user's corresponding data items stored and/or associated with a host computer system such as the data processing system 100 thereby creating a mirrored host computer on the device 210 with respect to such items. This is especially advantageous where the host computer system is the wireless device user's office computer system. Additional applications may also be loaded onto the device 210 through the network 220, the auxiliary I/O subsystem 128, the serial port 131, the short-range communications subsystem 141, or any other suitable subsystem 142, and installed by a user in RAM 126 or preferably in a non-volatile store (not shown) for execution by the microprocessor 138. Such flexibility in application installation increases the functionality of the device 210 and may provide enhanced on-device functions, communication-related functions, or both. For example, secure communication applications may enable electronic commerce functions and other such financial transactions to be performed using the wireless device 210.

In a data communication mode, a received signal such as a text message, an email message, an instant messaging (“IM”) message, or Web page download will be processed by the communication subsystem 111 and input to the microprocessor 138. The microprocessor 138 will preferably further process the signal for output to the display 122 and/or to the auxiliary I/O device 128. A user of the wireless device 210 may also compose data items, such as email and IM messages, for example, using the keyboard 132 in conjunction with the display 122, the clickable thumbwheel 230, and possibly the auxiliary I/O device 128. The keyboard 132 is preferably a complete alphanumeric keyboard and/or a telephone-type keypad. These composed items may be transmitted over a communication network 220 through the communication subsystem 111 or the short range communication subsystem 141.

For voice communications, the overall operation of the wireless device 210 is substantially similar, except that the received signals would be output to the speaker 134 and signals for transmission would be generated by the microphone 136. Alternative voice or audio I/O subsystems, such as a voice message recording subsystem, may also be implemented on the device 210. Although voice or audio signal output is preferably accomplished primarily through the speaker 134, the display 122 may also be used to provide, for example, an indication of the identity of a calling party, duration of a voice call, or other voice call related information.

The serial port 131 shown in FIG. 2 is normally implemented in a personal digital assistant (“PDA”)-type communication device for which synchronization with a user's desktop computer is a desirable, albeit optional, component. The serial port 131 enables a user to set preferences through an external device or software application and extends the capabilities of the device 210 by providing for information or software downloads to the device 210 other than through a wireless communication network 220. The alternate download path may, for example, be used to load an encryption key onto the device 210 through a direct and thus reliable and trusted connection to thereby provide secure device communication.

The short-range communications subsystem 141 shown in FIG. 2 is an additional optional component which provides for communication between the device 210 and different systems or devices, which need not necessarily be similar devices. For example, the subsystem 141 may include an infrared device and associated circuits and components, or a Bluetooth™ communication module to provide for communication with similarly-enabled systems and devices. (Bluetooth™ is a registered trademark of Bluetooth SIG, Inc.)

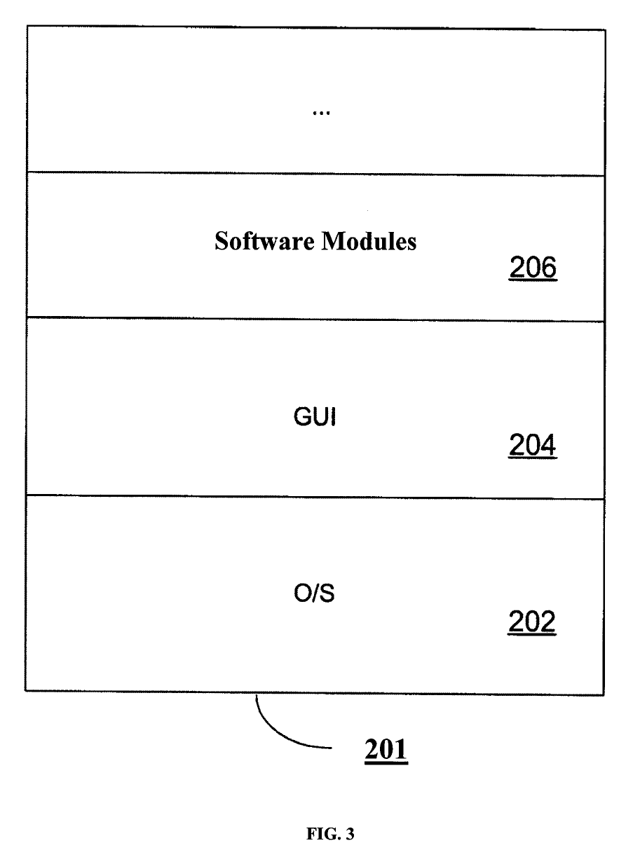

FIG. 3 is a block diagram illustrating a memory 201 of the wireless device 210 of FIG. 2. The memory 201 has various software components for controlling the device 210 and may include flash memory 124, RAM 126, or ROM (not shown), for example. In accordance with an embodiment of the invention, the wireless device 210 is intended to be a multi-tasking wireless communications device configured for sending and receiving data items and for making and receiving voice calls. To provide a user-friendly environment to control the operation of the device 210, an operating system (“O/S”) 202 resident on the device 210 provides a basic set of operations for supporting various applications typically operable through a graphical user interface (“GUI”) module 204. For example, the O/S 202 provides basic input/output system features to obtain input from the auxiliary I/O 128, the keyboard 132, the clickable thumbwheel 230, and the like, and for facilitating output to the user. Thus, a user may interact with the wireless device 210 and its software modules 206 using a graphical user interface (“GUI”) 180 displayed on the wireless device's display 122 through the operations of the GUI module 206. The wireless device's GUI 180 may be similar to that of the data processing system 100 as described above. Though not shown, one or more applications for managing communications or for providing personal digital assistant like functions may also be included in the wireless device 210.

Thus, the wireless device 210 includes computer executable programmed instructions for directing the device 210 to implement the embodiments of the present application. The programmed instructions may be embodied in one or more hardware or software modules 206 resident in the memory 201 of the wireless device 210. Alternatively, the programmed instructions may be embodied on a computer readable medium (such as a CD disk or floppy disk) which may be used for transporting the programmed instructions to the memory of the wireless device 210. Alternatively, the programmed instructions may be embedded in a computer-readable signal or signal-bearing medium that is uploaded to a network by a vendor or supplier of the programmed instructions, and this signal or signal-bearing medium may be downloaded through an interface 111, 131, 141 to the wireless device 210 from the network by end users or potential buyers.

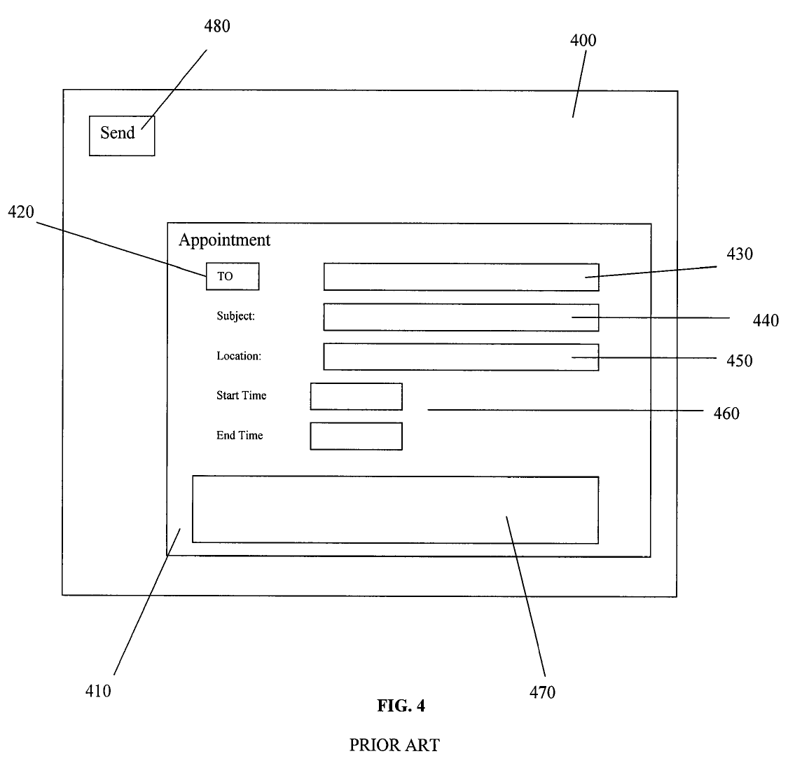

FIG. 4 is a screen capture illustrating an appointment window 410 of an exemplary graphical user interface (“GUI”) 400 for composing a meeting request. The GUI 400 may be displayed, for example, on the display screen 140 of the data processing system 100. The appointment window 410 includes a “To” field 430 for entering the names of attendees for the meeting. These names will form a list of attendees for the meeting. The attendees are selected by the meeting organizer. The appointment window also includes fields for defining the attributes or particulars of the meeting such as: a “Subject” field 440 for entering the title of the meeting, a “Location” field 450 for entering the location of the meeting, “Start time” and “End time” fields 460 for entering the start time and date and end time and date for the meeting, and a message field 470 for entering further details about the meeting. After completing the required fields in the appointment window 410, the meeting organizer may then select the “Send” button 480 of the GUI 400 to send the meeting request to the selected attendees. The meeting request will then be displayed in each attendee's email inbox and calendar.

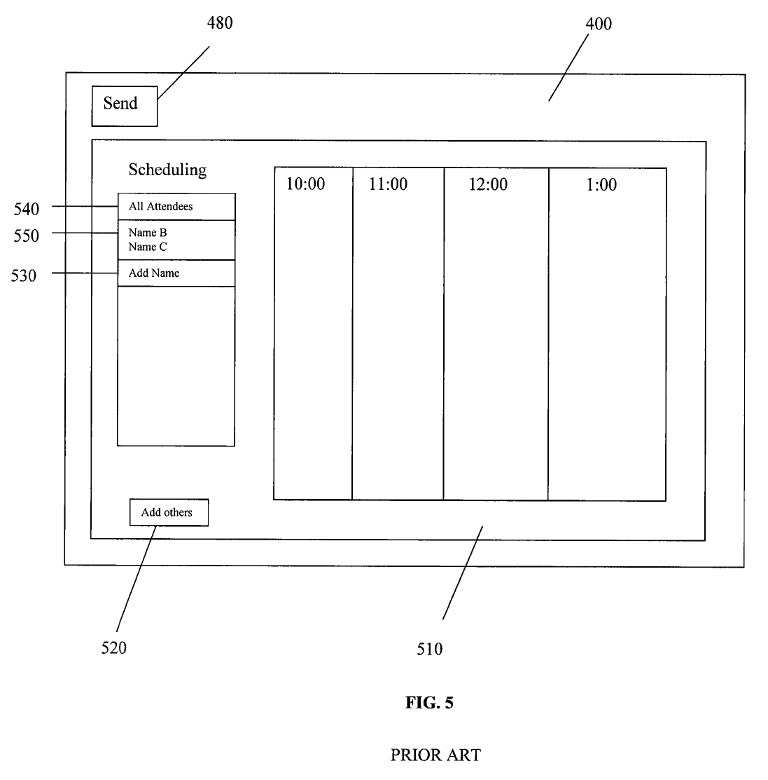

FIG. 5 is a screen capture illustrating a scheduling window 510 of the exemplary graphical user interface (“GUI”) 400 of FIG. 4. The scheduling window 510 includes an “All Attendees” column 540 for presenting a list of attendees 550 currently invited to the meeting. The meeting organizer may add an attendee to the list of attendees 550 by clicking on the “Add Name” field 530 presented at the bottom of the list 550 presented in the “All Attendees” column 540 and entering the name to be added.

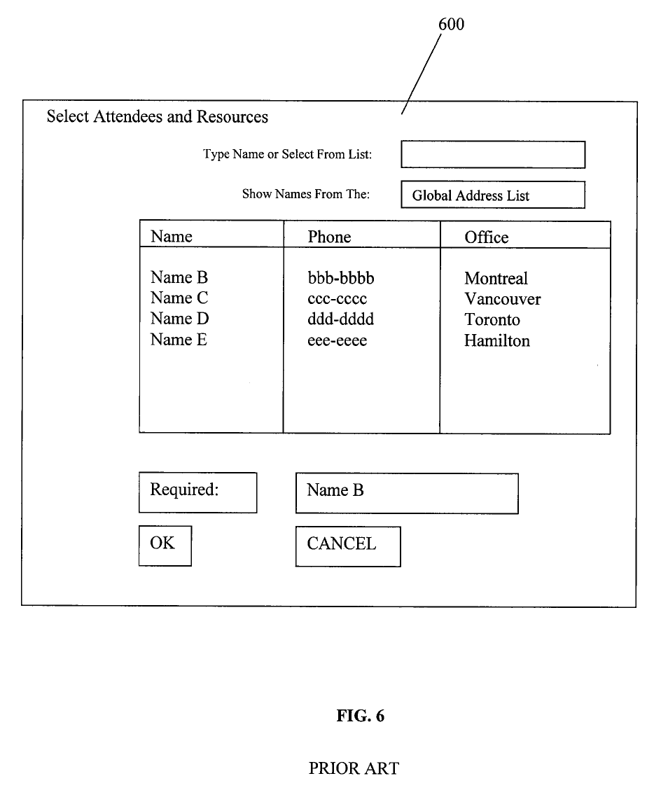

FIG. 6 is a screen capture illustrating an address book pop-up window 600 for selecting attendees for the meeting request of FIGS. 4 and 5. The pop-up window 600 may be displayed over the appointment 410 or scheduling windows 510 upon selection of the “To” button 420 and the “Add Others” button 520, respectively. The address book pop-up window 600 allows the user to add attendees to the meeting request from the address book of an associated email application.

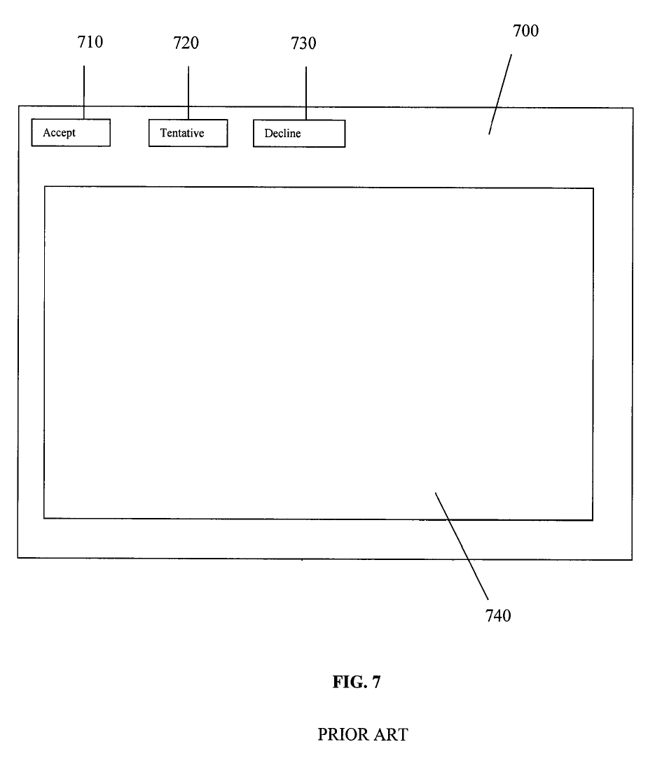

FIG. 7 is a screen capture illustrating a response window 700 for composing a meeting response to the meeting request of FIGS. 4 and 5. The response window 700 may be displayed, for example, on the display screen 122 of the wireless device 210. The response window 700 is opened when an attendee selects the meeting request from his or her email inbox or calendar. To respond to the meeting request, the attendee has to click one of the buttons 710, 720, 730 presented in the response window 700. When this is done, a meeting response is created and sent to the meeting organizer. In general, once an attendee responds, the request is removed from his or her inbox. The response buttons in the request are as follows. The “Accept” button 710 is selected when the attendee knows that he or she will be able to attend the meeting. When the attendee accepts a meeting, the meeting is scheduled in his or her calendar and he or she receives updates if the meeting organizer changes the details of the meeting. The “Decline” button 720 is selected when the attendee knows that he or she will not be able to attend the meeting. Declining a meeting deletes the item from the attendee's calendar (freeing that block of time), but it does not sever the attendees ties with the meeting: The attendee will still get updates if the meeting organizer makes them and the attendee will have the opportunity to respond to the update. If the attendee truly wants to opt out of a meeting, the attendee will have to ask the organizer to remove his or her name from the attendee list. The “Tentative” button 730 is selected when the attendee is interested in the meeting, but is not sure whether he or she will be able to attend. The response window 700 includes a message field 740 for entering a message to be delivered to the meeting organizer with the meeting response.

Now, consider the following scenario. User “A” creates a meeting request through the appointment window 410 of a calendar application such as that illustrated in FIGS. 4-7 and invites users “B”, “C”, and “D”. Thus, user A is the meeting organizer and users B, C, and D are the attendees. As mentioned above, one problem faced by users of such an application is that, as the meeting organizer, only user A can change the list of attendees (or invitees) 550. For example, user B may want to add a user E to the list of attendees 550. However, the only way to accomplish this effectively is for user B to ask user A to add user E to the list of attendees 550. This causes extra email and/or telephone use, and generally a waste of resources.

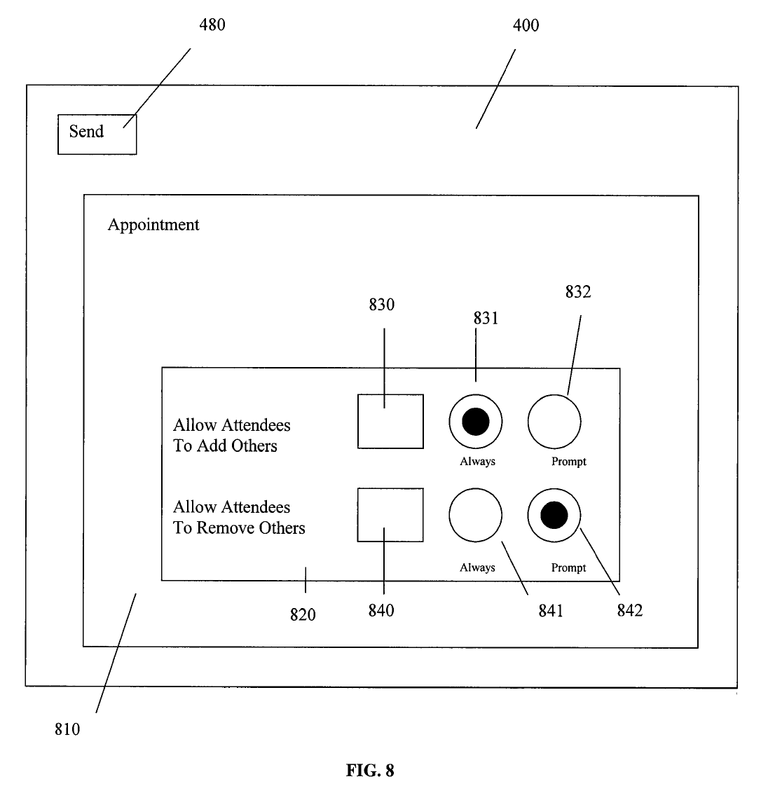

FIG. 8 is a screen capture illustrating an appointment window 810 of a graphical user interface (“GUI”) 400 for composing a meeting request in accordance with an embodiment of the application. According to the application, the meeting organizer (i.e., user A) can control whether the attendees may add/remove to/from the list of attendees 550. This can be accomplished by way of a dialog box such as the “Allow Attendees to Add Others/Allows Attendees to Remove Others” dialog box 820 shown in the appointment window 810 of FIG. 8. The dialog box 820 presents the meeting organizer with choices 830-832, 840-842 for configuring attendee access to the list of attendees 550 for the meeting. If the meeting organizer selects the “Allow Attendees to Add Others” checkbox 830 and then selects the corresponding “Always” radio button 831, attendees are allowed unfettered access to the list of attendees 550 for making additions. Similarly, if the meeting organizer checks the “Allow Attendees to Remove Others” checkbox 840 and then selects the corresponding “Always” radio button 841, attendees are allowed unfettered access to the list of attendees 550 for making removals. If the meeting organizer checks the “Allow Attendees to Add Others” checkbox 830 and then selects the corresponding “Prompt” radio button 832, attendees may send a request message to the meeting organizer for each of their proposed additions to the list of attendees 550. The meeting organizer may then either allow or deny the proposed addition. Similarly, if the meeting organizer checks the “Allow Attendees to Remove Others” checkbox 840 and then selects the corresponding “Prompt” radio button 842, attendees may send a request message to the meeting organizer for each of their proposed removals from the list of attendees 550. The meeting organizer may then either allow or deny the proposed removal. If the meeting organizer does not check either the “Allow Attendees to Add Others” checkbox 830 or the “Allow Attendees to Remove Others” checkbox 840, attendees are not allowed to add or remove attendees. Note that for each of the “Allow Attendees to Add Others” and “Allow Attendees to Remove Others” checkboxes 830, 840, the meeting organizer can select only one of the corresponding “Always” radio button 831, 841 and “Prompt” radio button 832, 842 at one time. That is, by selecting an “Always” radio button (e.g., 831), the corresponding “Prompt” radio button (i.e., 832) is unselected, and vice versa.

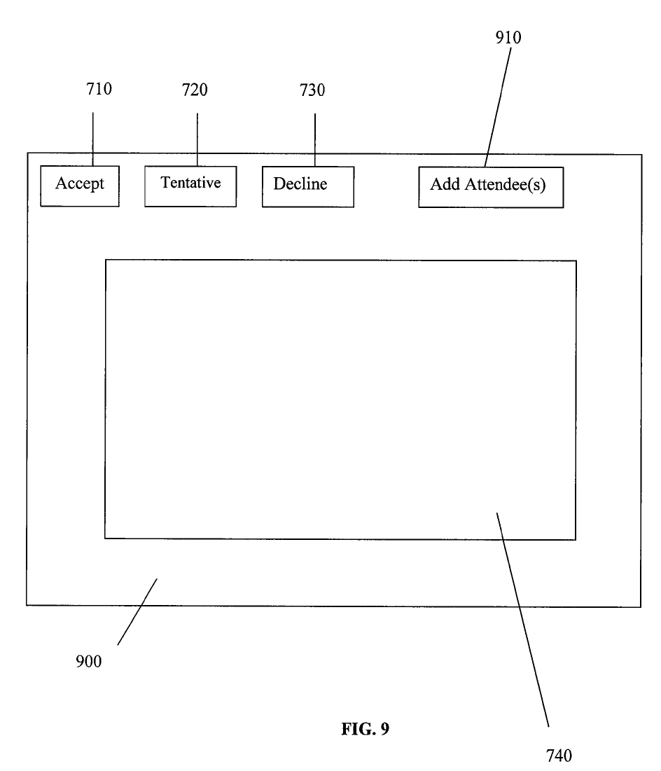

FIG. 9 is a screen capture illustrating a response window 900 for composing a meeting response to the meeting request of FIG. 8 in accordance with an embodiment of the application. If the meeting organizer selects the “Allow Attendees to Add Others” checkbox 830 from the “Allow Attendees to Add Others/Allow Attendees to Remove Others” dialog box 820 of FIG. 8, the response window 900 will include an “Add Attendee(s)” button or menu item 910 for an attendee to select if he or she wants to add attendees to the list of attendees 550 for the meeting. By selecting the “Add Attendee(s)” button 910, the attendee (i.e., user B) may be presented with a window, similar to the scheduling window 510 of FIG. 5 or the address book pop-up window 600 of FIG. 6, from which the attendee may add attendees (i.e., if the meeting organizer previously selected the “Always” radio button 831) or propose the addition of attendees (i.e., if the meeting organizer previously selected the “Prompt” radio button 832). Similarly, if the meeting organizer selects the “Allow Attendees to Remove Others” checkbox 840 from the “Allow Attendees to Add Others/Allow Attendees to Remove Others” dialog box 820 of FIG. 8, the response window 900 will include an “Remove Attendee(s)” button or menu item (not shown) for an attendee to select if he or she wants to remove attendees from the list of attendees 550 for the meeting. By selecting the “Remove Attendee(s)” button, the attendee (i.e., user B) may be presented with a window, similar to the scheduling window 510 of FIG. 5 or the address book pop-up window 600 of FIG. 6, from which the attendee may remove attendees (i.e., if the meeting organizer previously selected the “Always” radio button 841) or propose the removal of attendees (i.e., if the meeting organizer previously selected the “Prompt” radio button 842).

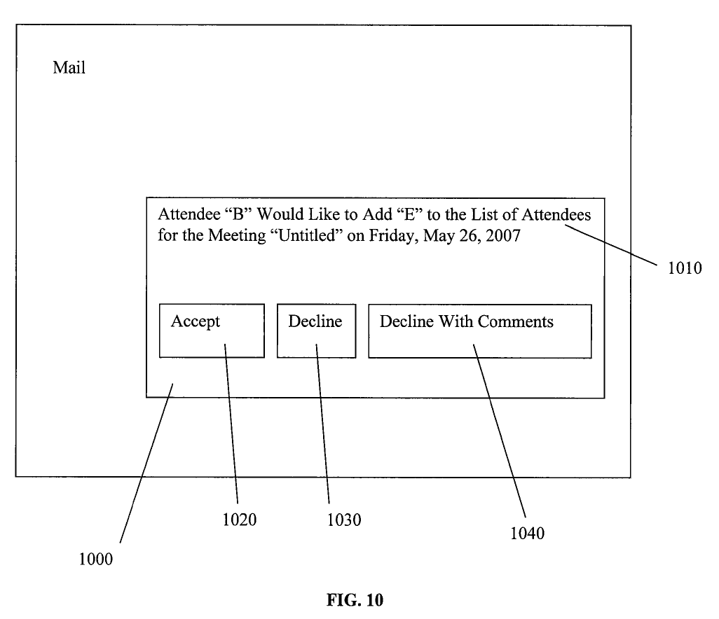

FIG. 10 is a screen capture illustrating an add attendee prompt dialog box 1000 in accordance with an embodiment of the application. If the meeting organizer (e.g., user A) previously selected the “Allow Attendees to Add Others” checkbox 830 and the corresponding “Prompt” radio button 832, upon an attendee's (e.g., user B) selecting of attendees for addition (e.g., user E) to the list of attendees 550, a message will be sent to the meeting organizer proposing the addition. This message may be in the form of an add attendee dialog box 1000 as shown in FIG. 10. The dialog box includes a text field 1010 outlining the proposed addition (i.e., the proposal or message) and choices 1020, 1030, 1040 for generating a response to the proposal. In FIG. 10, the proposal by user B is to add user E to the list of attendees 550. The text of the proposal for display to the meeting organizer (i.e., user A) in the text field 1010 of the dialog box 1000 is as follows: “Attendee ‘B’ Would Like to Add ‘E’ to the List of Attendees for the Meeting ‘Untitled’ on Friday, May 26, 2006”. If the meeting organizer chooses the “Accept” menu item or button 1020, the attendee's add proposal will be accepted. In this case, a response message may be generated and sent to the attendee to inform the attendee that his or her proposal has been accepted. In addition, the list of attendees 550 will be updated in accordance with the proposal. If the meeting organizer chooses the “Decline” menu item or button 1020, the attendee's add proposal will be declined. In this case, a response message may be generated and sent to the attendee to inform the attendee that his or her proposal has been declined. No changes will be made to the list of attendees 550. If the meeting organizer chooses the “Decline With Comment” menu item or button 1030, the attendee's add proposal will be declined. In this case, a response message may be generated and sent to the attendee to inform the attendee that his or her proposal has been declined. The response message may include comments provided by the meeting organizer in response to the attendee's proposal. Again, no changes will be made to the list of attendees 550. Similarly, a remove attendee prompt dialog box (not shown) may also be provided to accommodate the meeting organizer's (e.g., user A) previous selection of the “Allow Attendees to Remove Others” checkbox 840 and the corresponding “Prompt” radio button 842.

According to one embodiment, after the addition of an attendee to the attendee list 550, an updated attendee list 550 is automatically (or selectably) sent to the original attendees and a new meeting request message is sent to the added attendee (i.e., user E in the above example).

According to one embodiment, the meeting organizer may set properties for each attendee. These properties may include what each attendee is allowed to do with respect to organizing the meeting. For example, the properties may include the ability to add attendees to the list of attendees 550, the ability to remove attendees from the list of attendees 550, and the ability to change attributes of the meeting. The meeting attributes may include one or more of the list of attendees 550, a time for the meeting 460, a date for the meeting, a location for the meeting 450, a subject of the meeting 440, and a reoccurrence of the meeting. The meeting organizer may set these properties on a per attendee basis. The property settings may be stored as defaults for use in setting up new meetings hence making the set-up of new meetings more efficient. For example, the meeting organizer may assign his or her assistant properties providing full permission to modify the list of attendees 550 and any or all of the meeting attributes. In addition, a first group of selected attendees may be assigned properties allowing them to add attendees to the list of attendees 550. Furthermore, a second group of selected attendees may be assigned properties allowing them to only change a single meeting attribute such as the location for the meeting 450.

The method provides several advantages as follows. The “Always” option 831, 832 optimizes the process of changing the attendee list 550, reducing the need for the use of email or telephone by the meeting organizer and reducing the time required by the meeting organizer to update the attendee list 550. The “Prompt” option 832, 842 provides further efficiencies as the attendee can use the calendar user interface 400 to add a new attendee, and a request for the addition can be automatically sent to the meeting organizer, who can respond to the request efficiently by way of the add attendee prompt dialog box 1000.

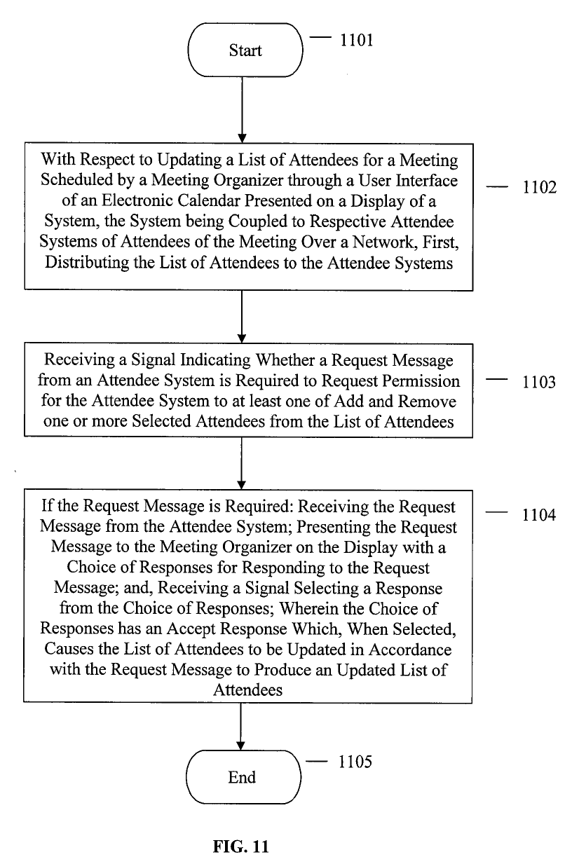

The above described method may be summarized with the aid of a flowchart. FIG. 11 is a flowchart illustrating operations 1100 of modules 206 within the memory of a data processing system (e.g., 210) for updating a list of attendees 550 for a meeting scheduled by a meeting organizer through a user interface 400 of an electronic calendar presented on a display 122 of the system 210, the system 210 being coupled to respective attendee systems (e.g., 100) of attendees of the meeting over a network 220, in accordance with an embodiment of the application.

At step 1101, the operations 1100 start.

At step 1102, the list of attendees 550 is distributed to the attendee systems 100.

At step 1103, a signal 832, 842 is received indicating whether a request message (e.g., 1010) from an attendee system 100 is required to request permission for the attendee system 100 to at least one of add and remove one or more selected attendees from the list of attendees 550.

At step 1104, if the request message 1010 is required: the request message 1010 is received from the attendee system 100; the request message 1010 is presented 1000 to the meeting organizer on the display 122 with a choice of responses 1020, 1030, 1040 for responding to the request message 1010; and, a signal is received selecting a response from the choice of responses. The choice of responses 1020, 1030, 1040 has an accept response 1020 which, when selected, causes the list of attendees 550 to be updated in accordance with the request message 1010 to produce an updated list of attendees.

At step 1105, the operations 1100 end.

The method may further include, if the request message 1010 is not required, allowing the attendee systems to update the list of attendees 550 to produce the updated list of attendees. The choice of responses 1020, 1030, 1040 may have a decline response 1030 which, when selected, causes no update to the list of attendees 550. The decline response 1030, when selected, may send a text message 1040 composed by the meeting organizer to the attendee system 100. The method may further include distributing the updated list of attendees to the attendee systems 100. The method may further include receiving a signal 830, 840 indicating whether the attendee systems 100 may at least one of add and remove one or more selected attendees from the list of attendees 550. The attendee systems 100 may be selected ones of the attendee systems 100. The method may further include receiving a signal indicating whether selected ones of the attendee systems 100 may alter one or more attributes of the meeting. The one or more attributes may include one or more of the list of attendees 550, a time for the meeting 460, a date for the meeting, a location for the meeting 450, a subject of the meeting 440, and a reoccurrence of the meeting. And, the network 220 may include a wireless network and a wired network and at least one of the system 210 and the attendee systems 100 may be a wireless device.

The above described method is generally performed by the wireless device 210. However, according to an alternate embodiment, the method can be performed by the data processing system 100 or any data processing system including, for example, a personal computer and a laptop computer.

While embodiments of this application are primarily discussed as a method, a person of ordinary skill in the art will understand that the apparatus discussed above with reference to a wireless device 210 and a data processing system 100, may be programmed to enable the practice of the method of the invention. Moreover, an article of manufacture for use with a wireless device 210 or data processing system 100, such as a pre-recorded storage device or other similar computer readable medium including program instructions recorded thereon, may direct the wireless device 210 or data processing system 100 to facilitate the practice of the method of these embodiments. It is understood that such apparatus and articles of manufacture also come within the scope of the application.

The embodiments of the application described above are intended to be exemplary only. Those skilled in this art will understand that various modifications of detail may be made to these embodiments, all of which come within the scope of the application.

What is claimed is:

1. A method for updating a list of attendees for a meeting scheduled by a meeting organizer through a user interface of an electronic calendar presented on a display of a system, the system being coupled to respective attendee systems of attendees of the meeting over a network, the method comprising:
distributing the list of attendees to the attendee systems;
receiving a signal indicating whether a request message from an attendee system is required to request permission for the attendee system to at least one of add and remove one or more selected attendees from the list of attendees;
if the request message is required: receiving the request message from the attendee system; presenting the request message to the meeting organizer on the display with a choice of responses for responding to the request message; and, receiving a signal selecting a response from the choice of responses; wherein the choice of responses has an accept response which, when selected, causes the list of attendees to be updated in accordance with the request message to produce an updated list of attendees.

2. The method of claim 1 and further comprising, if the request message is not required, allowing the attendee systems to update the list of attendees to produce the updated list of attendees.

3. The method of claim 1 wherein the choice of responses has a decline response which, when selected, causes no update to the list of attendees.

4. The method of claim 3 wherein the decline response, when selected, sends a text message composed by the meeting organizer to the attendee system.

5. The method of claim 2 and further comprising distributing the updated list of attendees to the attendee systems.

6. The method of claim 1 and further comprising receiving a signal indicating whether the attendee systems may at least one of add and remove one or more selected attendees from the list of attendees.

7. The method of claim 6 wherein the attendee systems are selected ones of the attendee systems.

8. The method of claim 1 and further comprising receiving a signal indicating whether selected ones of the attendee systems may alter one or more attributes of the meeting.

9. The method of claim 8 wherein the one or more attributes include one or more of the list of attendees, a time for the meeting, a date for the meeting, a location for the meeting, a subject of the meeting, and a reoccurrence of the meeting.

10. The method of claim 1 wherein the network includes a wireless network and a wired network and at least one of the system and the attendee systems is a wireless device.

11. A system for updating a list of attendees for a meeting scheduled by a meeting organizer through a user interface of an electronic calendar presented on a display of the system, the system being coupled to respective attendee systems of attendees of the meeting over a network, the system comprising:
a processor coupled to memory and to an interface to the network; and,
modules within the memory and executed by the processor, the modules including:
a module for distributing the list of attendees to the attendee systems;
a module for receiving a signal indicating whether a request message from an attendee system is required to request permission for the attendee system to at least one of add and remove one or more selected attendees from the list of attendees;
a module for, if the request message is required:
receiving the request message from the attendee system;
presenting the request message to the meeting organizer on the display with a choice of responses for responding to the request message; and, receiving a signal selecting a response from the choice of responses;
wherein the choice of responses has an accept response which, when selected, causes the list of attendees to be updated in accordance with the request message to produce an updated list of attendees.

12. The system of claim 11 and further comprising, a module for, if the request message is not required, allowing the attendee systems to update the list of attendees to produce the updated list of attendees.

13. The system of claim 11 wherein the choice of responses has a decline response which, when selected, causes no update to the list of attendees.

14. The system of claim 13 wherein the decline response, when selected, sends a text message composed by the meeting organizer to the attendee system.

15. The system of claim 12 and further comprising a module for distributing the updated list of attendees to the attendee systems.

16. The system of claim 11 and further comprising a module for receiving a signal indicating whether the attendee systems may at least one of add and remove one or more selected attendees from the list of attendees.

17. The system of claim 16 wherein the attendee systems are selected ones of the attendee systems.

18. The system of claim 11 and further comprising a module for receiving a signal indicating whether selected ones of the attendee systems may alter one or more attributes of the meeting.

19. The system of claim 18 wherein the one or more attributes include one or more of the list of attendees, a time for the meeting, a date for the meeting, a location for the meeting, a subject of the meeting, and a reoccurrence of the meeting.

20. The system of claim 11 wherein the network includes a wireless network and a wired network and at least one of the system and the attendee systems is a wireless device.
